(19) United States
(12) Patent Application Publication
(10) Pub. No.: US 2016/0011019 A1
(43) Pub. Date: Jan. 14, 2016

(54) Measuring system, a measuring method and a computer-program product for resource-saving measurement

(71) Applicant: Rohde & Schwarz GmbH & Co. KG, Munich (DE)

(72) Inventor: Peter Wolanin, Kranzberg (DE)

(21) Appl. No.: 14/796,785

(22) Filed: Jul. 10, 2015

(30) Foreign Application Priority Data
Jul. 11, 2014 (DE) 102014213524.9

(51) Int. Cl. G01D 9/00

(52) U.S. Cl. CPC G01D 9/005

(57) ABSTRACT

A measuring system (105) serves for the measurement of a device under test (108). It contains a measuring device (107) and a control unit (182). This measuring device (107) comprises a measuring unit (173) which is controlled by the control unit (182) in order to implement the measurement of the device under test (108). The control unit (182, 282) is either arranged in the device under test (108, 208) or the measuring system (5) comprises a control computer (6), the control unit (62) is arranged within the control computer (6) and the measuring device (7) then does not comprise a control unit for controlling the measurement.

### RELATED APPLICATION

This application claims priority of German patent application DE 10 2014 213 524.9 filed on Jul. 11, 2014, which is incorporated by reference herewith.

### FIELD OF THE INVENTION

The invention relates to a measuring system, a measuring method and a computer-program product which are suitable for measuring a device under test.

### BACKGROUND OF THE INVENTION

In a conventional measuring system, a control computer controls the measuring device in order to measure a device under test. In this context, the control computer and also the measuring device both comprise a control unit. For example, DE 10 2011 084 143 A1 discloses a measuring system of this kind.

The disadvantage with such a measuring system is that the control computer and also the measuring device must both comprise cost-intensive processors, because effort-intensive processing steps must be carried out in both devices.

The invention has the object among others of providing a measuring system, a measuring method, a computer program and a computer-program product which have only minimal hardware requirements.

### SUMMARY OF THE INVENTION

A measuring system according to a first aspect of the invention serves for the measurement of a device under test.

It contains a measuring device and a control unit. In this context, the measuring device comprises a measuring unit which is controlled by the control unit in order to implement the measurement of the device under test.

In a first preferred alternative embodiment, this control unit is arranged within the device under test. An additional control computer can be dispensed with in this manner. Accordingly, the device under test controls the measuring device in order to implement the measurement. As an alternative, the measuring system comprises a control computer in which the control unit is arranged. In this case, the measuring device itself does not contain a control unit for controlling the measurement of the device under test. Accordingly, effort-intensive processes within the measuring device can be dispensed with. Otherwise, in both embodiments, the measuring system according to the invention achieves a saving of at least one control unit.

In a further preferred development of the second alternative with a control computer as described above, the control computer comprises a communications unit. The measuring device also comprises a communications unit. In this context, the communications units are embodied to communicate with one another. Accordingly, the control unit is embodied to control the measurement by the measuring unit by means of the communications units. Through the use of the communications units, a simple exchange of the measuring device or respectively of the control computer is possible, because standard communications protocols can be used.

By preference, this control unit is embodied to execute a measurement software, which is embodied to control the measurement by the measuring unit by means of the communications units. The measurement software is accordingly executed on the control computer. Accordingly, the measuring device need not provide a processor which can execute a measurement software. A very simple embodiment of the measuring device is therefore possible.

In a preferred alternative embodiment, which corresponds to the first alternative, the control unit is arranged in the device under test. The device under test to be measured is therefore a part of the measuring system. Accordingly, the device under test comprises a communications unit. The measuring device therefore also comprises a communications unit. In this context, the communications units are embodied to communicate with one another. The control unit of the device under test is therefore embodied to control the measurement by the measuring unit at least indirectly by means of the communications units. Through the use of the communications units, different devices under test and measuring devices can therefore be used without difficulty, because standard communications protocols, for example, of an IEC bus system or of a CAN bus system, can be used via the communications units.

In this context, the measuring device advantageously comprises a further control unit. The control unit of the device under test is accordingly embodied to control the further control unit of the measuring device by means of the communications units in order to control the measurement by means of the measuring unit. In this manner, the hardware effort can be divided between the device under test and the measuring device, since both comprise one control unit each. This is particularly relevant if the control unit already installed in the device under test does not provide a sufficiently high computational performance to implement all of the processing steps of the measurement. Furthermore, conventional measuring devices which comprise a control unit and a measuring unit can be used with this embodiment.

By preference in this context, the first control unit, that is, the control unit of the device under test, is embodied to execute a first measurement software. In this case, the further control unit, that is, the control unit of the measuring device, is embodied to execute a second measurement software. The first measurement software is accordingly embodied to control the second measurement software by means of the communications units in order to control the measurement by means of the measuring unit. Accordingly, a simple and resource-saving measurement is possible without the use of an external control computer.

In a preferred alternative embodiment, the measuring device itself does not comprise a control unit for controlling the measurement of the device under test. The control unit of the device under test is then embodied to control the measurement by means of the measuring unit directly by means of the communications units. In this manner, resource-intensive processes within the measuring device can be dispensed with. The measuring device alone is not capable of implementing measurements but requires an external control unit for this purpose.

By preference, the control unit is embodied in this context to execute a first measurement software. In this case, the first measurement software is embodied to control the measurement by means of the measuring unit by means of the communications units. Accordingly, a very simple and resource-saving measurement is possible.

By greatest preference, the control unit of the device under test is thus embodied to keep the measurement software buffered after a delivery of the device under test and to execute the first measurement software in the case of a service operation. In this manner, at the cost of a small storage requirement, it is possible to implement measurements with a very simple measuring device possibly without its own processing unit in the case of a subsequent service operation after delivery.

A measuring method according to a second aspect of the invention serves for the measurement of a device under test. A control unit controls the measurement of the device under test by a measuring unit. In this context, the control unit is either arranged in the device under test or arranged in a control computer, wherein the measuring device then does not comprise a control unit for controlling the measurement. A very simple and resource-saving measurement is therefore possible.

By preference, all of the parameters of the device under test which must be measured are stored in the device under test together with the measurement software. Accordingly, the measuring device or respectively the control computer need no longer comprise detailed information relating to the device under test to be measured. This achieves great flexibility in the use of the measuring system.

Furthermore, with the measures described above, the structural size of the measuring system can be significantly reduced. It is therefore possible to use very much shorter cable lengths and numbers of cables than with conventional measuring systems.

A further advantage of the communications system described, especially of the communications system without a control computer, as described, is that effort-intensive type tests for industrial computers can be dispensed with, and that the software can be loaded into the device under test, for example, a mobile telephone, for instance, as an app.

### BRIEF DESCRIPTION OF THE DRAWINGS

The invention is described by way of example in the following on the basis of the drawings in which an advantageous exemplary embodiment of the invention is illustrated. The drawings show:

FIG. 1 an overview of an exemplary measuring system;

FIG. 2 an exemplary measuring system in a block-circuit diagram;

FIG. 3 a first exemplary embodiment of the measuring system according to the invention in a block-circuit diagram;

FIG. 4 a second exemplary embodiment of the measuring system according to the invention in a block-circuit diagram;

FIG. 5 a third exemplary embodiment of the measuring system according to the invention in a block-circuit diagram;

FIG. 6 a first exemplary embodiment of the measuring method according to the invention in a flow chart;

FIG. 7 a second exemplary embodiment of the measuring method according to the invention in a flow chart; and

FIG. 8 a third exemplary embodiment of the measuring method according to the invention in a flow chart.

### DETAILED DESCRIPTION OF THE PREFERRED EMBODIMENTS

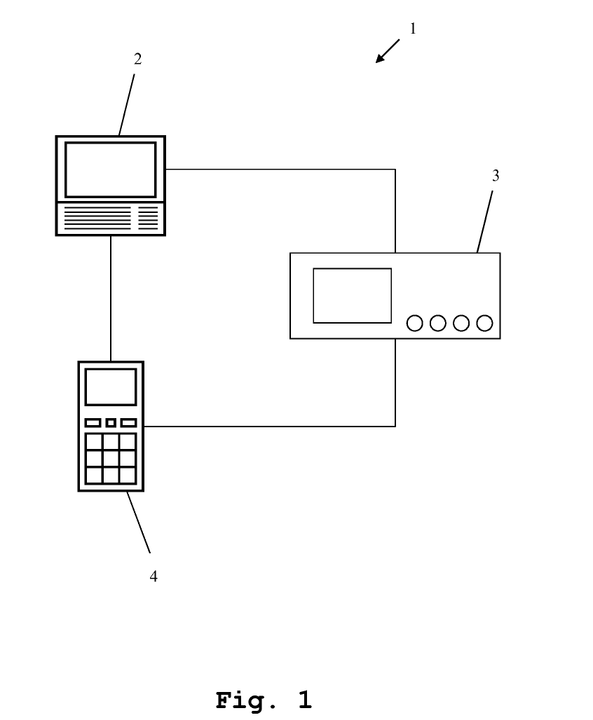

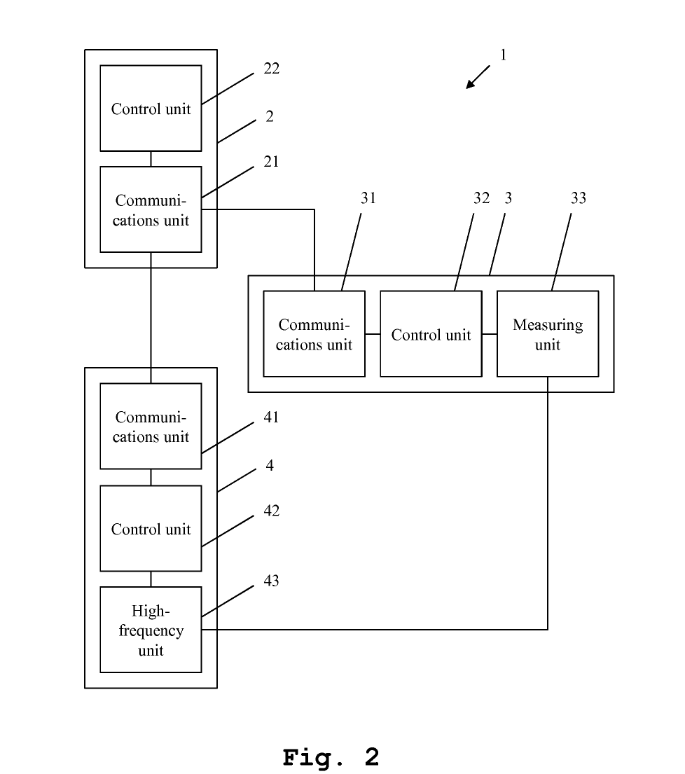

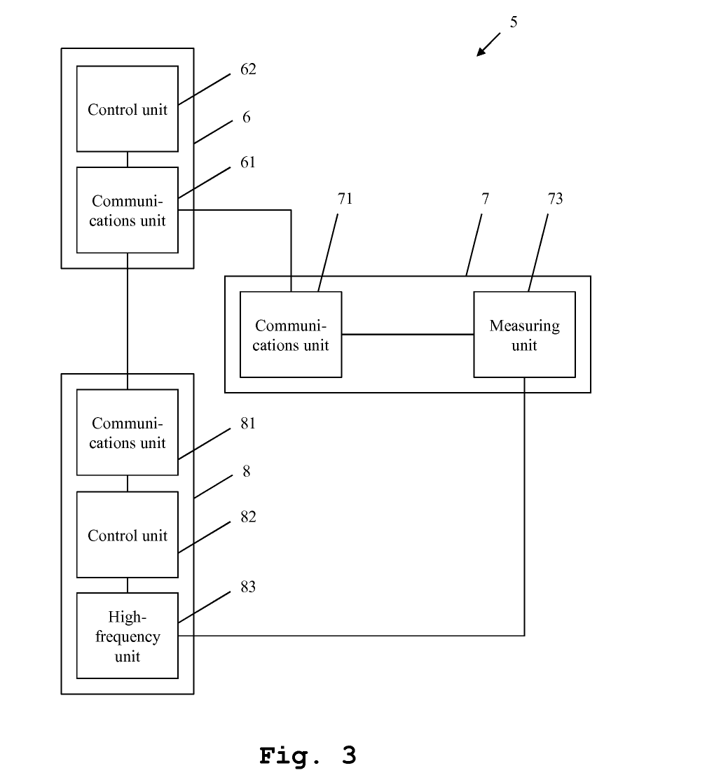

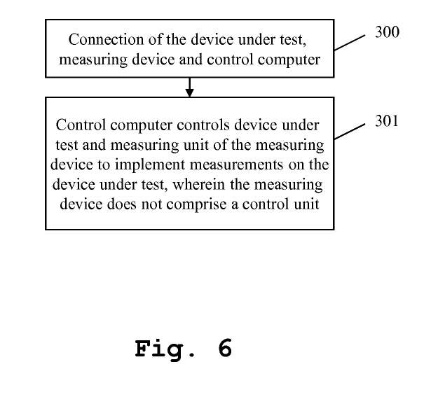

On the basis of FIGS. 1-2, the construction and general functioning of an exemplary measuring system will first be explained. The construction and functioning of different exemplary embodiments of the measuring system according to the invention will then be described with reference to FIGS. 3-5. Finally, the functioning of several exemplary embodiments of the measuring method according to the invention will be described with reference to FIGS. 6-8. The presentation and description of identical elements in similar drawings has not been repeated in some cases.

FIG. 1 shows an exemplary measuring system 1. The measuring system 1 comprises a control computer 2, connected to the latter a measuring device 3 and, connected to this a device under test 4. In this context, the device under test 4 is not a part of the measuring system 1.

Furthermore, the control computer 2 and the device under test 4 are connected to one another. The control computer 2 in this context controls the measuring device 3 so that the latter implements a measurement on the device under test 4. Additionally, the control computer 2 controls the device under test 4 in such a manner that the latter cooperates in the measurement. The control computer 2 and also the measuring device 3 in this context both comprise control units which require a significant hardware effort. Additionally, the device under test 4 also optionally comprises a control unit.

FIG. 2 shows a block-circuit diagram of the measuring system 1 illustrated in FIG. 1. The control computer 2 comprises a communications unit 21 and a control unit 22 which are connected to one another. The measuring device 3 comprises a communications unit 31 which is connected to a control unit 32. The latter is connected in turn to a measuring unit 33. The device under test 4 accordingly comprises a communications unit 41, which is connected to a control unit 42. The latter is connected in turn to a high-frequency unit 43. The communications unit 21 of the control computer is connected in this context to the communications unit 31 of the measuring device and to the communications unit 41 of the device under test. Furthermore, the measuring unit 33 of the measuring device is connected to the high-frequency unit 43 of the device under test 4.

The control unit 22 of the control computer 2 controls the measuring unit 33 by means of the communications units 21, 31 and the control unit 32 in such a manner that the former implements a measurement of the device under test. In this context, signals are transmitted from the measuring unit 33 to the high-frequency unit 43 of the device under test 4. Furthermore, the signals from the high-frequency unit 43 to the measuring unit 33 are received by the latter and transmitted to the control unit 32 for further processing. Furthermore, the control unit 22 of the control computer 2 controls the control unit 42 of the device under test by means of the communications units 21, 41 in such a manner that the device under test 4 cooperates in the measurement.

Accordingly, the control computer 2, the measuring device 3 and the device under test 4 each comprise a control unit 22, 32, 42. Accordingly, a significant hardware effort is required in order to implement a measurement of the device under test 4 with the exemplary measuring system 1.

FIG. 3 shows a first exemplary embodiment of the measuring system 5 according to the invention in a block-circuit diagram. In this context, the measuring system 5 comprises a control computer 6 which contains a control unit 62 and a communications unit 61, which are connected to one another, and a measuring device which provides a communications unit 71 and, connected to the latter a measuring unit 73. A device under test 8 which comprises a communications unit 81, a control unit 82 and a high-frequency unit 83 is not a part of this measuring system 5. The communications unit 81 and the high-frequency unit 83 are accordingly each connected to the control unit 82 of the device under test 8.

In the measuring system 5 according to the invention shown in FIG. 3, the control unit 62 of the control computer 6 accordingly controls the measuring unit 73 of the measuring device 7 by means of the communications unit 61, 71 so that the latter implements a measurement of the device under test 8. In this context, the measuring unit 73 transmits high-frequency signals to the high-frequency unit 83 of the device under test and receives signals generated by the high-frequency unit 83. In this context, the signals are further processed by the measuring unit 73 only minimally and transmitted by means of the communications unit 71 to the communications unit 61 of the control computer. The signals are rerouted by the latter to the control unit 62 which processes them further.

In this context, the control unit 62 executes a measurement software which, by means of the communications units 61, 71, controls the measuring unit 73.

As already described with reference to FIG. 2, in this context, the control unit 62 further controls the control unit 82 of the device under test 8 by means of the communications units 61 and 81 in such a manner that the former cooperates with the measurement.

By contrast with the measuring system 1 presented in FIG. 1 and FIG. 2, with the measuring system 5 presented here, the majority of the resource-intensive post-processing of the measurement results is implemented in the control unit 62 of the control computer 6. Accordingly, a substantially more simply constructed measuring device 7 can be used.

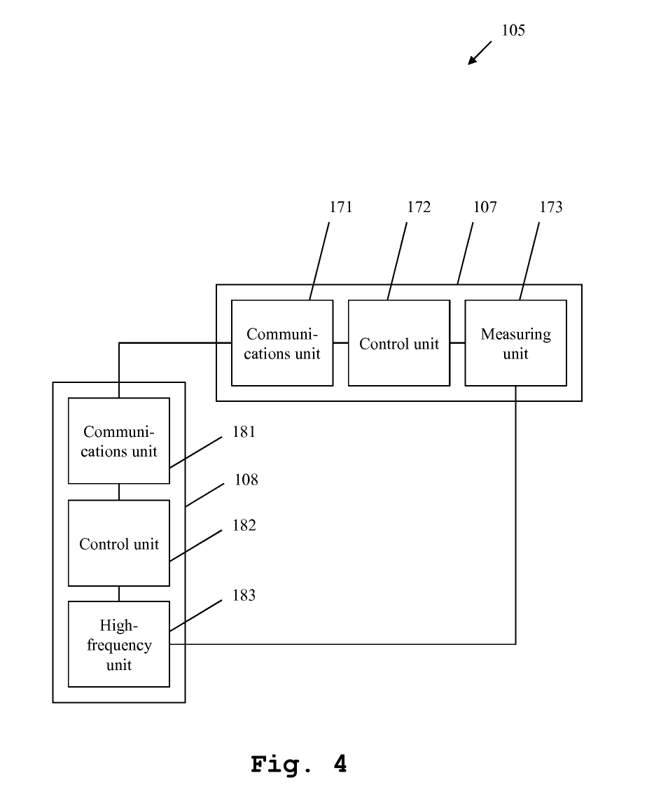

A second exemplary embodiment of the measuring system 105 according to the invention is presented in FIG. 4. The measuring system 105 accordingly comprises a measuring device 107 which provides a communications unit 171 connected to a control unit 172. For its part, the control unit 172 is connected in turn to a measuring unit 173. Furthermore, the measuring system 105 comprises a device under test 108, which comprises a communications unit 181 connected to a control unit 182. For its part, the control unit 182 is connected to a high-frequency unit 183. In this context, the high-frequency unit 183 is connected to the measuring unit 173, while the communications unit 171 is connected to the communications unit 181. With the measuring system 105 presented here, an external control computer, as shown in FIGS. 1-3, is dispensed with.

In order to implement a measurement, the control unit 182 of the device under test 108 controls the control unit 172 of the measuring device 107 by means of the communications units 181 and 171, so that the latter implements a control of the measuring unit 173 in order to implement the measurement of the device under test 108. At the same time, the control unit 182 of the device under test 108 places the device under test 108 into a condition in which it is ready for a measurement. Accordingly, the measuring unit 173 transmits signals to the high-frequency unit 183 and receives resulting signals from the high-frequency unit 183. The received signals are minimally further processed by the measuring unit 173 and transmitted to the control unit 172. The control unit 172 completes the resource-intensive processing steps.

In this context, the control unit 182 executes a first measurement software. The control unit 172 executes a second measurement software. The first measurement software accordingly controls the second measurement software by means of the communications units 181, 171 in order to control the measuring unit 173 to implement the measurement.

It is therefore possible to dispense with the external control computer and accordingly with the resource-intensive control unit installed within the latter.

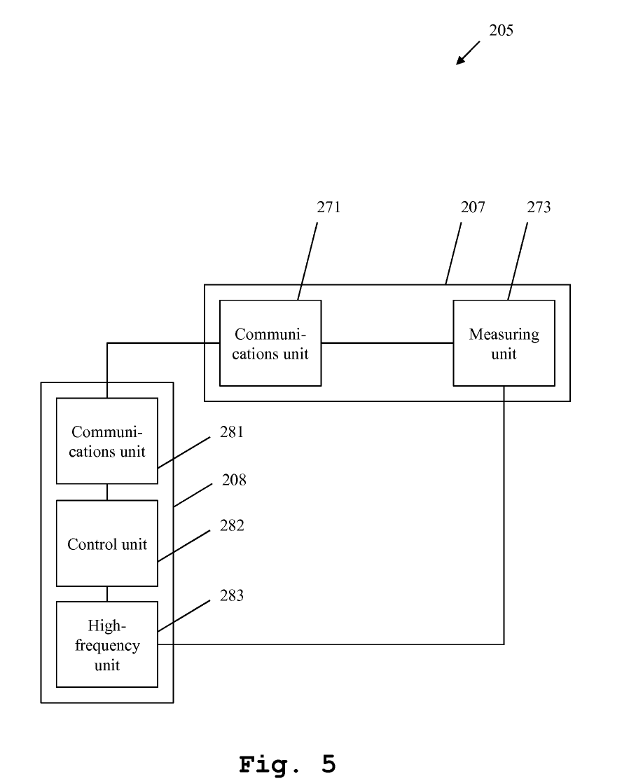

A third exemplary embodiment of the measuring system 205 is presented in FIG. 5. Here also, the measuring system 205 comprises only a measuring device 207 and a device under test 208. This measuring device 207 comprises a communications unit 271, which is connected to a measuring unit 273. The device under test 208 accordingly comprises a communications unit 281, which is connected to a control unit 282. Furthermore, it comprises a high-frequency unit 283, which is also connected to the control unit 282.

In order to implement a measurement, the control unit 282 controls the measuring unit 273 by means of the communications units 281, 271 in such a manner that the latter transmits signals to the high-frequency unit 283 and receives signals transmitted by the high-frequency unit 283. The received signals are further processed by the measuring unit 273 only minimally and then transmitted by means of the communications units 271, 281 to the control unit 282. In this context, the control unit 282 implements all of the resource-intensive further processing steps on the signals.

The control unit 282 accordingly executes a measurement software which controls the measuring unit 273 by means of the communications units 281, 271 to implement the measurement. In this manner, a measuring device without its own control unit can also be used. This further reduces the resource intensity of the measuring system.

Instead of the tethered connections between the control computer, measuring device and device under test illustrated in the exemplary embodiments, wireless connections can also be used. Wireless connections can be established between the communications units, for example, via Bluetooth, Wi-Fi, GSM, UMTS, LTE etc. The connection between the measuring unit and the high-frequency unit can also dispense with a line. In this case, the measuring unit and also the high-frequency unit each comprises an antenna.

Since modern mobile communications devices which are often used as devices under test, now comprise several independent communications standards, for example, Bluetooth, Wi-Fi, GSM, UMTS, LTE, Nearfield, these different radio units can exchange their roles during the measurement. For example, while a Bluetooth connection is measured by the measuring unit and the high-frequency unit, communication is possible via the communications units by means of one of the other standards.

FIG. 6 shows a first exemplary embodiment of the measuring system according to the invention in a flow chart. In a first step 300, a device under test, a measuring device and a control computer are connected to one another. In a second step 301, the control computer controls the device under test and the measuring unit of the measuring device to implement measurements on the device under test. The measuring device accordingly does not comprise a control unit. By dispensing with a control unit within the measuring device, a very resource-saving measurement can be achieved.

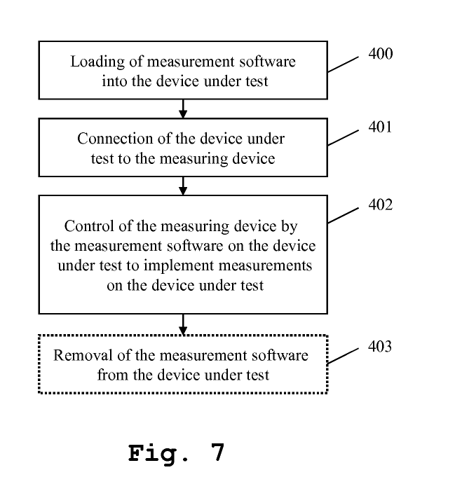

FIG. 7 shows a second exemplary embodiment of the measuring method according to the invention in a flow chart. In a first step 400, a measurement software is loaded into the device under test. This can be implemented, for example, by writing to a flash memory. In a second step 401, the device under test is connected to a measuring device. In a third step 402, the measuring device is controlled by the measurement software disposed in the device under test in order to implement measurements on the device under test. In this context, the measuring device implements the measurements autonomously. The post-processing of the measurement results takes place within the measuring device. In an optional fourth step 403, the measurement software is removed from the device under test. If the step 403 is executed, storage space in the device under test can be released, which is then available for the actual use of the device under test. Alternatively, the execution of the fourth step 403 can be dispensed with. In this case, the measurement software is available on the device under test for subsequent service operations and need not be loaded again.

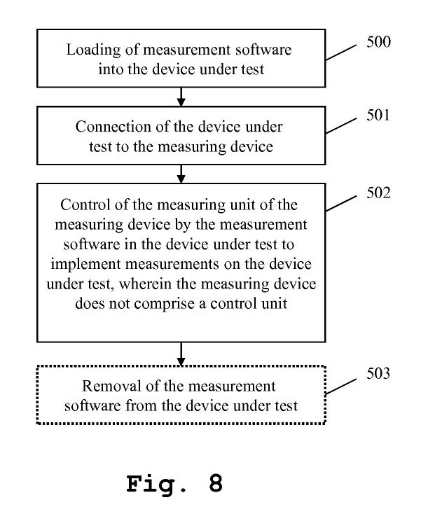

FIG. 8 shows a third exemplary embodiment of the measuring method according to the invention in a flow chart. In a first step 500, a measurement software is loaded into the device under test. In a second step 501, the device under test is connected to a measuring device. In a third step 502, the measurement software in the device under test controls the measuring unit of the measuring device to implement measurements on the device under test. The measuring device itself does not comprise a control unit. In this context, all of the post-processing steps are implemented by the device under test itself.

In an optional step 503, the measurement software is again removed from the device under test. If the step 503 is implemented, storage space on the device under test can be released. If the step 503 is not implemented, the measurement software is available for subsequent service operations.

The invention is not restricted to the exemplary embodiment illustrated. In particular, an extremely wide variety of measuring devices can be used. Advantageously, all of the features described above or features shown in the drawings can be combined with one another arbitrarily within the scope of the invention.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. A measuring system for measuring a device under test, with a measuring device and a first control unit,
wherein the measuring device comprises a measuring unit,
wherein the control unit is embodied to control the measurement of the device under test by the measuring unit,
wherein the control unit is arranged in the device under test, or
wherein the measuring system comprises a control computer, the control unit is arranged within the control computer, and the measuring device does not comprise a control unit for controlling the measurement.

2. The measuring system according to claim 1,
wherein the measuring system (5) comprises a control computer,
wherein the first control unit is arranged within the control computer, and the measuring device does not comprise a control unit for controlling the measurement,
wherein the control computer comprises a communications unit,
wherein the measuring device comprises a communications unit,
wherein the communications units of the control computer and of the measuring device are embodied to communicate with one another, and
wherein the first control unit is embodied to control the measurement by the measuring unit by means of the communications units.

3. The measuring system according to claim 2,
wherein the first control unit is embodied to execute a measurement software, which is embodied to control the measurement by the measuring unit by means of the communications units.

4. The measuring system according to claim 1,
wherein the first control unit is arranged in the device under test,
wherein the device under test to be measured is a part of the measuring system,
wherein the device under test comprises a communications unit,
wherein the measuring device comprises a communications unit,
wherein the communications units of the device under test and of the measuring device are embodied to communicate with one another, and wherein the control unit is embodied to control the measurement by the measuring unit at least indirectly by means of the communications units.

5. The measuring system according to claim 4,
wherein the measuring device comprises a further control unit, and
wherein the control unit of the device under test is embodied to control the further control unit by means of the communications units in order to control the measurement by means of the measuring unit.

6. The measuring system according to claim 5,
wherein the first control unit is embodied to execute a first measurement software,
wherein the further control unit is embodied to execute a second measurement software, and
wherein the first measurement software is embodied to control the second measurement software by means of the communications units in order to control the measurement by means of the measuring unit.

7. The measuring system according to claim 4,
wherein the measuring device does not comprise a control unit for controlling the measurement of the device under test, and
wherein the first control unit of the device under test is embodied to control the measurement by means of the measuring unit directly by means of the communications units.

8. The measuring system according to claim 7,
wherein the first control unit is embodied to execute a first measurement software, and
wherein the first measurement software is embodied to control the measurement by means of the measuring unit by means of the communications units.

9. The measuring system according to claim 6,
wherein the control unit of the device under test, is embodied to keep the first measurement software buffered after a delivery, and
wherein to execute the first measurement software in the case of a service operation.

10. A measuring method for measuring a device under test,
wherein a first control unit controls the measurement of the device under test by a measuring unit,
wherein the control unit is arranged in the device under test and controls from there,
or
wherein the control unit is arranged in a control computer and controls from there, wherein the measuring device does not comprise a control unit for controlling the measurement.

11. The measuring method according to claim 10,
wherein the first control unit is arranged in a control computer,
wherein the measuring device does not comprise a control unit for controlling the measurement,
wherein communications units of the control computer and of the measuring device communicate with one another, and
wherein the first control unit controls the measurement by the measuring unit by means of the communications units.

12. The measuring method according to claim 11,
wherein the first control unit executes a measurement software which controls the measurement by the measuring unit by means of the communications units.

13. The measuring method according to claim 10,
wherein the first control unit is arranged in the device under test,
wherein the communications units of the device under test and of the measuring device communicate with one another, and
wherein the first control unit controls the measurement by the measuring unit at least indirectly by means of the communications units.

14. The measuring method according to claim 13,
wherein a first control unit of the device under test controls a further control unit of the measuring device by means of the communications units in order to control the measurement by means of the measuring unit.

15. The measuring method according to claim 14,
wherein the control unit executes a first measurement software,
wherein the further control unit executes a second measurement software, and
wherein the first measurement software controls the second measurement software by means of the communications units in order to control the measurement by means of the measuring unit.

16. The measuring method according to claim 13,
wherein the measuring device does not comprise a control unit for controlling the measurement of the device under test, and
wherein the first control unit of the device under test controls the measurement by means of the measuring unit directly by means of the communications units.

17. The measuring method according to claim 16,
wherein the control unit executes a first measurement software, and
wherein the first measurement software controls the measurement by means of the measuring unit by means of the communications units.

18. The measuring method according to claim 15,
wherein the control unit of the device under test keeps the first measurement software buffered after a delivery and executes it in the case of a service operation.

19. A computer program with program-code means for the implementation of all of the steps of a method, for measuring a device under test,
wherein a first control unit controls the measurement of the device under test by a measuring unit,
wherein the control unit is arranged in the device under test and controls from there,
or
wherein the control unit is arranged in a control computer and controls from there, wherein the measuring device does not comprise a control unit for controlling the measurement.

20. The measuring system according to claim 8,
wherein the control unit of the device under test, is embodied to keep the first measurement software buffered after a delivery, and
wherein to execute the first measurement software in the case of a service operation.
